(19) United States
(12) Patent Application Publication
(10) Pub. No.: US 2019/0294135 A1
(43) Pub. Date: Sep. 26, 2019

(54) CONTENT DELIVERY TO VEHICLE VIA CHARGING STATION

(71) Applicant: FORD GLOBAL TECHNOLOGIES, LLC, Dearborn, MI (US)

(72) Inventors: Daniel Joseph MADRID, Livonia, MI (US); William Lawrence FRANTZ, Ferndale, MI (US); Chad Christopher BOES, Plymouth, MI (US); David SEXTON, Canton, MI (US)

(21) Appl. No.: 15/928,927

(22) Filed: Mar. 22, 2018

(51) Int. Cl. G05B 19/042; B60L 11/18; G06Q 10/02; H04L 29/08

(52) U.S. Cl. CPC G05B 19/0426; B60L 11/1846; G05B 2219/23324; H04L 67/34; B60L 2270/40; G06Q 10/02

(57) ABSTRACT

A vehicle charging system includes a charge station comprising a controller that is in communication with a server. The controller is programmed to, responsive to receiving a reservation request including content request data, request the server to send content to the controller prior to a reservation start time, receive and store the content, and, responsive to a vehicle associated with the reservation request receiving power from the charge station, transfer the content to the vehicle.

### TECHNICAL FIELD

This application generally relates to a system delivering digital content to a vehicle while connected to a charge station and capable of receiving power from the charge station.

### BACKGROUND

Electrified vehicles include a rechargeable battery that is used to provide at least partial power for propulsion and other vehicle functions. Battery power may be used during vehicle operation, thereby reducing the state of charge of the battery. In the absence of an onboard charger, the electrified vehicle may be coupled to a charging station to charge the battery. Charging stations are typically configured to provide power to the vehicle. Charging stations may include an interface directed to controlling the charging process. For example, the charge station and vehicle may exchange signals for controlling the power transfer. The signal interface consists of hardwired signals that may be pulse width modulated (PWM) signals to control various aspects of the charging process.

### SUMMARY

A charge station includes a controller in communication with a server and programmed to, responsive to receiving a reservation request including content request data, request the server to send content to the controller prior to a reservation start time, receive and store the content, and, responsive to a vehicle associated with the reservation request receiving power from the charge station, transfer the content to the vehicle.

The content request data may include a vehicle interrogator log with a vehicle identification number and hardware and software identifiers for programmable controllers within the vehicle. The content request data may include a request for one or more media files. The reservation request may include the reservation start time and a reservation end time and the controller may be further programmed to generate an estimated vehicle download time and, responsive to the estimated vehicle download time exceeding an amount of time corresponding to a difference between the reservation end time and the reservation start time, generate output to notify a requestor of insufficient time for downloading. The controller may be further programmed to request at least one vehicle-based controller to stop communicating on a vehicle internal communication network to allow increased bandwidth for transferring content. The controller may be further programmed to request a reduction in power to at least one vehicle-based system that is not receiving the content to offset power drawn by a vehicle controller that is receiving the content. The controller may be further programmed to generate an estimated vehicle download time and communicate the estimated vehicle download time associated with the content to a requestor.

A vehicle charging system includes a server programmed to, responsive to receiving a reservation request for a charge station including a content request associated with a vehicle, send content corresponding to the content request prior to a reservation start time to a controller associated with the charge station and programmed to store the content and, responsive to the vehicle receiving power from the charge station, transfer the content to the vehicle.

The content request may include a vehicle interrogator log with a vehicle identification number and hardware and software identifiers for programmable controllers within the vehicle. The content request may include a request for one or more media files. The reservation request may include the reservation start time and a reservation end time and the server may be further programmed to, responsive to an estimated vehicle download time exceeding an amount of time corresponding to a difference between the reservation end time and the reservation start time, generate output to notify a requestor of insufficient time for downloading. The controller may be further programmed to request at least one vehicle-based controller to stop communicating on a vehicle internal communication network to allow increased bandwidth for transferring content. The controller may be further programmed to request a reduction in power to at least one vehicle-based system that is not receiving the content to offset power drawn by a vehicle controller that is receiving the content.

A method includes receiving, by a server, a reservation request for a charge station including a reservation time and vehicle identification data for a vehicle, selecting a software update corresponding to the vehicle identification data, and sending the software update to a charge station for storage prior to the reservation time. The method further includes downloading, by the charge station, the software update to the vehicle responsive to the vehicle receiving power from the charge station.

The vehicle identification data may include a vehicle identification number and hardware and software identifiers for programmable controllers within the vehicle. The reservation request may include a content request for one or more media files. The method may further includes sending, by the server, the media files to the charge station for storage prior to the reservation time; and downloading, by the charge station, the media files to the vehicle responsive to the vehicle receiving power from the charge station. The method may further include estimating, by the server, a download time to the vehicle for the software updates. The reservation request may include an arrival time and a departure time and the method may further include, responsive to the download time exceeding an amount of time corresponding to a difference between the departure time and the arrival time, notifying a requestor of insufficient time for downloading. The reservation request may include an arrival time and a departure time and the method may further include, responsive to the download time being less than an amount of time corresponding to a difference between the departure time and the arrival time, notifying a requestor of sufficient time for downloading.

### BRIEF DESCRIPTION OF THE DRAWINGS

FIG. 1 is a possible configuration of a vehicle communication system.

FIG. 2 is a possible configuration for a vehicle and charge station connected by a physical cable.

FIG. 3 is a possible configuration for a vehicle and charge station with wireless connections.

FIG. 4 is a possible flow chart for a sequence of operations for preparing a reservation request for a vehicle charging system.

FIG. 5 is a possible flow chart for a sequence of operations for transferring content to a vehicle in a vehicle charging system.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

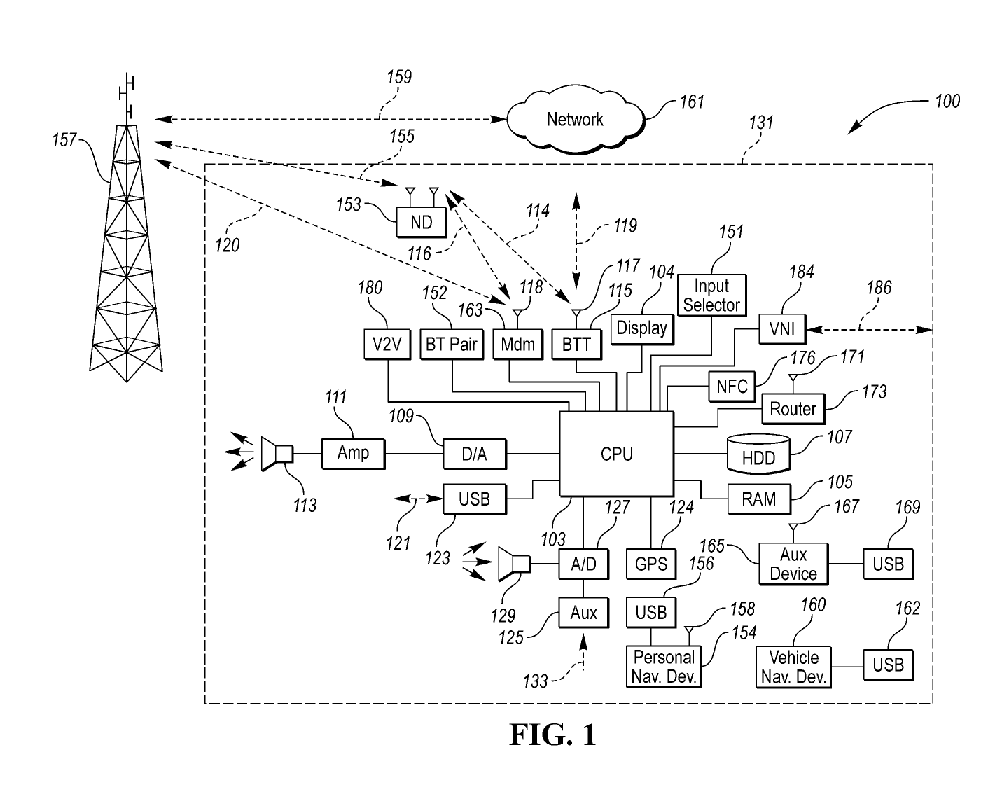

FIG. 1 illustrates an example block topology for a vehicle-based computing system 100 (VCS) for an electrified vehicle 131. An example of such a vehicle-based computing system 100 is the SYNC system manufactured by THE FORD MOTOR COMPANY. The vehicle 131 enabled with the vehicle-based computing system 100 may contain a visual front-end interface 104 located in the vehicle 131. The user may be able to interact with the interface 104 if it is provided, for example, with a touch sensitive screen. In another illustrative embodiment, the interaction occurs through, button presses, spoken dialog system with automatic speech recognition and speech synthesis.

In the illustrative embodiment shown in FIG. 1, at least one vehicle processor 103 controls at least some portion of the operation of the vehicle-based computing system 100. Provided within the vehicle 131, the processor 103 allows onboard processing of commands and routines. Further, the vehicle processor is connected to both non-persistent storage 105 and persistent storage 107. In this illustrative embodiment, the non-persistent storage 105 is random access memory (RAM) and the persistent storage 107 is a hard disk drive (HDD) or flash memory. Non-transitory memory may include both persistent memory and RAM. In general, persistent storage 107 may include all forms of memory that maintain data when a computer or other device is powered down. These include, but are not limited to, HDDs, CDs, DVDs, magnetic tapes, solid state drives, portable USB drives and any other suitable form of persistent memory.

The vehicle processor 103 may also include several different inputs allowing the user and external systems to interface with the vehicle processor 103. The vehicle-based computing system 100 may include a microphone 129, an auxiliary input port 125 (for input 133), a Universal Serial Bus (USB) input 123, a Global Positioning System (GPS) input 124, a screen 104, which may be a touchscreen display, and a BLUETOOTH input 115. The VCS 100 may further include an input selector 151 that is configured to allow a user to swap between various inputs. Input from both the microphone 129 and the auxiliary connector 125 may be converted from analog to digital by an analog-to-digital (A/D) converter 127 before being passed to the vehicle processor 103.

Electronic modules in the electrified vehicle 231 may communicate via one or more vehicle networks 186. The vehicle network 186 may include a plurality of channels for communication. One channel of the vehicle network 186 may be a serial bus such as a Controller Area Network (CAN). One of the channels of the vehicle network 186 may include an Ethernet network defined by Institute of Electrical and Electronics Engineers (IEEE) 802 family of standards. Additional channels of the vehicle network 186 may include discrete connections between modules and may include power signals from an energy management system. Different signals may be transferred over different channels of the vehicle network 186. For example, video signals may be transferred over a high-speed channel (e.g., Ethernet) while control signals may be transferred over CAN or discrete signals. Other communication channels of the vehicle network 186 may include a Local Interconnect Network (LIN) bus, a Media Oriented System Transport (MOST) bus, an Ethernet bus, and/or a FlexRay bus. The VCS 100 may include a vehicle network interface (VNI) 184 that is configured to interface the vehicle processor 103 with the vehicle network 186. The vehicle network interface 184 may include any hardware and software components for transferring signals and data between electronic modules. Communication over the vehicle network 186 may be according to a specified protocol. The specified protocol may define various periodic messages and diagnostic messages that are supported by controllers connected to the vehicle network 186.

Outputs from the vehicle processor 103 may include, but are not limited to, a visual display 104 and a speaker 113 or stereo system output. The speaker 113 may be connected to an amplifier 111 and receive its signal from the vehicle processor 103 through a digital-to-analog (D/A) converter 109. Outputs can also be made to a remote BLUETOOTH device such as a Personal Navigation Device (PND) 154 or a USB device such as vehicle navigation device 160 along the bi-directional data streams shown at 119 and 121 respectively.

In one illustrative embodiment, the system 100 uses the BLUETOOTH transceiver 115 with an antenna 117 to communicate with a user's nomadic device 153 (e.g., cell phone, smart phone, Personal Digital Assistance (PDA), or any other device having wireless remote network connectivity). The nomadic device 153 can then be used to communicate over a tower-network communication path 159 with a network 161 outside the vehicle 131 through, for example, a device-tower communication path 155 with a cellular tower 157. In some embodiments, the tower 157 may be a wireless Ethernet or WiFi access point as defined by Institute of Electrical and Electronics Engineers (IEEE) 802.11 family of standards. Exemplary communication between the nomadic device 153 and the BLUETOOTH transceiver 115 is represented by Bluetooth signal path 114.

Pairing the nomadic device 153 and the BLUETOOTH transceiver 115 can be instructed through a button 152 or similar input. Accordingly, the CPU is instructed that the onboard BLUETOOTH transceiver 115 will be paired with a BLUETOOTH transceiver in a nomadic device 153.

Data may be communicated between the vehicle processor 103 and the network 161 utilizing, for example, a data-plan, data over voice, or Dual Tone Multi Frequency (DTMF) tones associated with nomadic device 153. Alternatively, it may be desirable to include an onboard modem 163 having antenna 118 in order to establish a vehicle-device communication path 116 for communicating data between the vehicle processor 103 and the network 161 over the voice band. The nomadic device 153 can then be used to communicate over the tower-network communication path 159 with a network 161 outside the vehicle 131 through, for example, device-tower communication path 155 with a cellular tower 157. In some embodiments, the modem 163 may establish a vehicle-tower communication path 120 directly with the tower 157 for communicating with network 161. As a non-limiting example, modem 163 may be a USB cellular modem and vehicle-tower communication path 120 may be cellular communication.

In one illustrative embodiment, the vehicle processor 103 is provided with an operating system including an application programming interface (API) to communicate with modem application software. The modem application software may access an embedded module or firmware on the BLUETOOTH transceiver 115 to complete wireless communication with a remote BLUETOOTH transceiver (such as that found in a nomadic device 153). Bluetooth is a subset of the IEEE 802 PAN (personal area network) protocols. IEEE 802 LAN (local area network) protocols include WiFi and have considerable cross-functionality with IEEE 802 PAN. Both are suitable for wireless communication within a vehicle. Other wireless communication means that can be used in this realm is free-space optical communication (such as IrDA) and non-standardized consumer IR protocols or inductive coupled means including but not limited to near-field communications systems such as RFID.

In another embodiment, nomadic device 153 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of Code Division Multiple Access (CDMA), Time Division Multiple Access (TDMA), Space-Division Multiple Access (SDMA) for digital cellular communication, including but not limited to Orthogonal Frequency-Division Multiple Access (OFDMA) which may include time-domain statistical multiplexing. These are all International Telegraph Union (ITU) International Mobile Telecommunication (IMT) 2000 (3G) compliant standards and offer data rates up to 2 Mbps for stationary or walking users and 385 Kbps for users in a moving vehicle. 3G standards are now being replaced by IMT-Advanced (4G) which offers 100 Mbps for users in a vehicle and 1 Gbps for stationary users. If the user has a data-plan associated with the nomadic device 153, it is possible that the data-plan allows for broad-band transmission and the system could use a much wider bandwidth (speeding up data transfer). In still another embodiment, nomadic device 153 is replaced with a cellular communication device (not shown) that is installed to vehicle 131. In yet another embodiment, the nomadic device 153 may be a wireless local area network (LAN) device capable of communication over, for example (and without limitation), an IEEE 802.11g network (i.e., WiFi) or a WiMax network.

In one embodiment, incoming data can be passed through the nomadic device 153 via a data-over-voice or data-plan, through the onboard BLUETOOTH transceiver 115 and to the vehicle's internal processor 103. In the case of certain temporary data, for example, the data can be stored on the HDD or other storage media 107 until the data is no longer needed.

Additional sources that may interface with the vehicle 131 include a personal navigation device 154, having, for example, a USB connection 156 and/or an antenna 158, a vehicle navigation device 160 having a USB 162 or other connection, an onboard GPS device 124, or remote navigation system (not shown) having connectivity to network 161. USB is one of a class of serial networking protocols. IEEE 1394 (FireWire™ (Apple), i.LINK™ (Sony), and Lynx™ (Texas Instruments)), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the vehicle processor 103 may be in communication with a variety of other auxiliary devices 165. The auxiliary devices 165 can be connected through a wireless (e.g., via auxiliary device antenna 167) or wired (e.g., auxiliary device USB 169) connection. Auxiliary devices 165 may include, but are not limited to, personal media players, wireless health devices, portable computers, and the like.

The vehicle processor 103 may be connected to one or more Near Field Communication (NFC) transceivers 176. The NFC transceivers 176 may be configured to establish communication with compatible devices that are in proximity to the NFC transceivers 176. The NFC communication protocol may be useful for identifying compatible nomadic devices that are proximate the NFC transceivers 176.

Also, or alternatively, the vehicle processor 103 may be connected to a vehicle-based wireless router 173, using for example a WiFi (IEEE 802.11) transceiver/antenna 171. This may allow the vehicle processor 103 to connect to remote networks in range of the local router 173. In some configurations, the router 173 and the modem 163 may be combined as an integrated unit. However, features to be described herein may be applicable to configurations in which the modules are separate or integrated.

The vehicle processor 103 may interface to a vehicle-to-vehicle (V2V) communication system 180 or transceiver. The V2V communication system 180 may be a Dedicated Short-Range Communication (DSRC) system configured to transmit and receive messages directly between vehicles and infrastructure devices when within a predetermined range of one another. The V2V communication system 180 may implement established communication protocols.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments, particular components of the VACS may perform particular portions of a process depending on the particular implementation of the system. By way of example and not limitation, if a process has a step of sending or receiving information with a paired wireless device, then it is likely that the wireless device is not performing the process, since the wireless device would not “send and receive” information with itself. One of ordinary skill in the art will understand when it is inappropriate to apply a particular VACS to a given solution. In all solutions, it is contemplated that at least the vehicle computing system (VCS) located within the vehicle itself is capable of performing the exemplary processes.

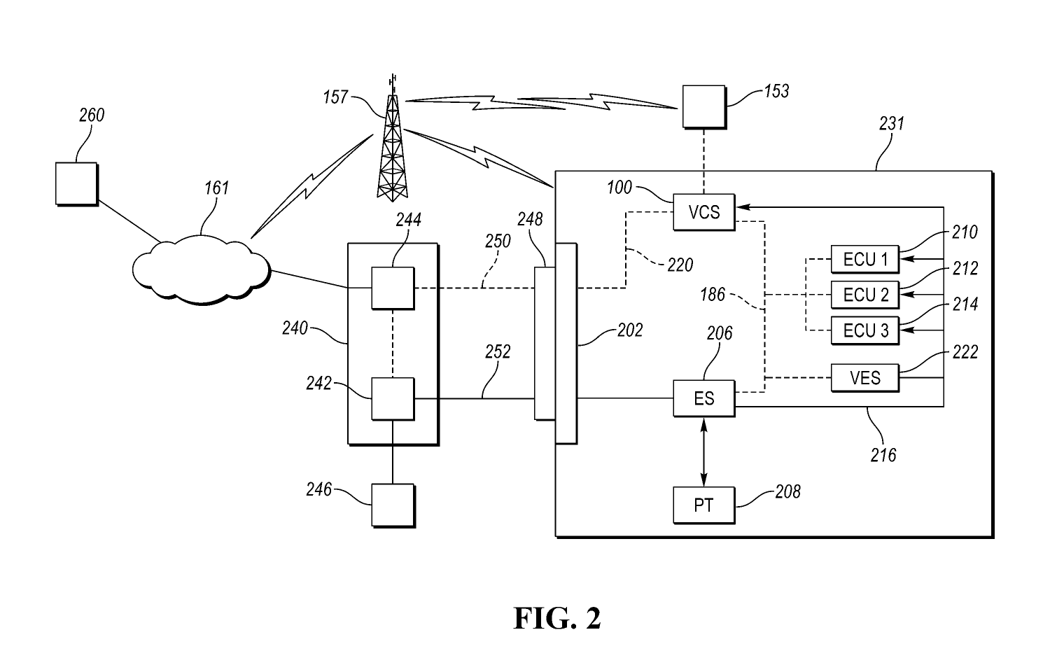

FIG. 2 depicts a first configuration for a vehicle charging system that includes a charge station 240 and an electrified vehicle 231. The electrified vehicle 231 may be configured to provide propulsion by using electrical energy that is stored onboard. The electrified vehicle 231 may include an energy storage system 206. The energy storage system 206 may include one or more batteries that are configured to store electrical energy. The energy storage system 206 may include any components and modules that are configured to distribute electrical energy from the batteries to other electrical modules. The energy storage system 206 may be configured to provide a high-voltage power channel and a low-voltage power channel 216. The low-voltage power channel 216 may provide low-voltage power (e.g., 12 Volts) to operate electrical components. The high-voltage power channel may provide high-voltage power (e.g., 400 Volts) to operate a propulsion motor. The energy storage system 206 may be configured to selectively enable and disable providing power on any of the power channels. The energy storage system 206 may be configured to be recharged from an external source. The energy storage system 206 may be configured to receive power from onboard sources.

The electrified vehicle 231 may include a powertrain 208 that utilizes one or more electric machines to provide propulsion. The electric machines may also provide regenerative energy to the energy storage system 206 (e.g., regenerative braking). The electrified vehicle 231 may be an electric vehicle in which the powertrain 208 provides all of the propulsive demand with the electric machine using power from the energy storage system 206. The electrified vehicle 231 may be a plug-in hybrid that includes an internal combustion engine. The powertrain 208 may include one or more power electronics modules that are configured to operate the electric machines.

The electrified vehicle 231 may include a Vehicle Entertainment System (VES) 222. The VES 222 may be configured to playback audio and video media files. The VES 222 may include a display screen for viewing video content. The VES 222 may include speakers or may interface with the speakers 113 of the VCS 100 for listening to audio content. The VES 222 may include non-volatile memory for storing content. For example, the VES 222 may include one or more display screens for viewing by rear-seat passengers. The display screens may be touch screens to permit a control interface to be implemented. Content may be received from the VCS 100. The VCS 100 may receive the content from any of the associated communication channels or device ports. The VES 222 may also utilize the display 104 of the VCS 100 for playing media and/or controlling operation of the system.

The electrified vehicle 231 may include a charge port 202 that is configured to couple the electrified vehicle 231 to a charge station 240. One or more power and power control conductors from the charge port 202 may be electrically coupled to the energy storage system 206. For example, power conductors may be connected to the batteries and power control conductors may be coupled to an energy management controller.

The charge station 240 may include a power transfer module 242 that is electrically coupled to an external power source 246 (e.g., electrical grid). The power transfer module 242 may be electrically coupled to a charge plug 248 through a power cable 252. The power cable 252 may include power and control conductors. The charge plug 248 may be configured to electrically couple a power output of the power transfer module 242 to a power conductor input of the charge port 202. When the charge plug 248 is connected to the charge port 202, power may be transferred to the vehicle to recharge the energy storage system 206.

The charge station 240 may also include a charge station controller 244. The charge station controller 244 may be configured to control the operation of the power transfer module 242. The charge station controller 244 may also be configured to manage the interface of the charge plug 248 with the charge port 202. For example, the charge station controller 244 may include hardware and software components to detect when the charge plug 248 is connected to the charge port 202. The charge station controller 244 may also interface with the energy storage system 206 via power control conductors for managing operation of the charge process.

The charge station controller 244 may include a network interface. For example, the charge station controller 244 may include a wired and/or wireless Ethernet interface for establishing a connection with the network 161 and/or cloud. The charge station controller 244 may include hardware circuitry and software drivers to operate the network interface.

A full recharge of the energy storage system 206 of the electrified vehicle 231 may take some time to complete. The completion time may be a function of the state of charge of the energy storage system 206 and the power capability of the charge station 240. In order to receive energy from the charge station 240, the electrified vehicle 231 may need to remain stationary in close proximity to the charge station 240. In this configuration, the charge plug 248 may be connected to the charge port 202 which limits possible movement for charging. As the vehicle is stationary, the time during recharging may provide time to perform other tasks that may not be possible during driving or may be costlier during driving. For example, the recharging time may provide an opportunity to download content to the electrified vehicle 231. Content may include software update files and instructions and media that includes audio and video files.

The vehicle 231 may include the vehicle-based computing system 100 as described previously herein. The charge port 202 may include a vehicle data connection 220. For example, the charge port 202 may include an Ethernet port for providing the vehicle data connection 220.

The charge station 240 may include a charge station data connection 250 that is compatible with the vehicle data connection 220 (e.g., Ethernet). The charge plug 248 may include a mating connector such that when the charge plug 248 is connected to the charge port 202, a connection is established between the charge station controller 244 and the vehicle-based computing system 100. For example, Ethernet conductors may be electrically coupled between the charge station controller 244 and the VCS 100.

In some configurations, the power connection and the data connection are established when the charge plug 248 is connected to the charge port 202. In some configurations, the charge plug 248 may include two separate connectors for the power connection and the data connection. The charge port 202 may include two separate mating receptacles. The wired connection may be useful as fast data transfer rates may be achieved with minimum electromagnetic interference. The wired connection may provide enhanced security as the connection may not be monitored without physical access to the vehicle network.

Shown in FIG. 2 are additional Electronic Control Units (ECU) that are connected to the vehicle network 186. For example, a first ECU (ECU1) 210, a second ECU (ECU2) 212, and a third ECU (ECU3) 214 may be coupled to the vehicle network 186. The first ECU 210, the second ECU 212, and the third ECU 214 may be programmable controllers. That is, the controllers may be configured to be programmed with new software. In some cases, reprogramming may be initiated by a dealership when a software update is available. In some cases, reprogramming may be initiated by the vehicle-based computing system 100 via a cellular connection. In addition, the VES 222 may be coupled to the vehicle network 186. The controllers may receive power from the low-voltage power channel 216. Each of the controllers may be selectively enabled and disabled via commands over the vehicle network 186. That is, the controllers may be commanded to start or stop drawing power from the low-voltage power channel 216 when requested. This may include placing the controller in a low-power mode of operation to reduce power consumption.

Controllers in the vehicle may be configured to be reprogrammed. Each of the controllers may implement a diagnostic protocol that includes reprogramming instructions and sequences. Reprogramming may take place by connecting a diagnostic tool to a diagnostic port that is coupled to the vehicle network 186. The diagnostic tool may send instructions and updates to the controllers using the diagnostic protocol. Other methods of initiating controller updates are also possible. Such methods may require physical access to the vehicle and diagnostic port.

A server 260 may be in communication with the network 161. The server 260 may include a library of software updates for the electrified vehicle 231. To reprogram the controllers (e.g., ECU1 210, ECU2 212, and ECU3 214) in the electrified vehicle 231, the server 260 may transfer the software updates to the electrified vehicle 231. In order to determine which software updates are applicable, the electrified vehicle 231 may be configured to transfer vehicle identification data to the server 260. For example, the vehicle-based computing system 100 may maintain and/or generate a Vehicle Interrogator Log (VIL). The VIL may include a Vehicle Identification Number (VIN) and hardware/software combinations for all electronic modules. The hardware/software combinations may be represented by part numbers and version numbers. The electrified vehicle 231 may transfer the VIL to the server 260 for processing. The server 260 may be programmed to process the VIL information to determine software updates for the electrified vehicle 231. When the applicable software updates for the electrified vehicle 231 are determined, the software update and instructions may be transferred to the electrified vehicle 231.

For example, in an Over-The-Air (OTA) update, the vehicle-based computing system 100 may communicate with the server via a cellular interface or wireless interface. Cellular signals may be sent between the electrified vehicle 231 and the network 161 through the cellular tower 157. The VCS 100 may be programmed to maintain the VIL. The VCS 100 may query the electronic modules (e.g., ECU1 210, ECU2 212, and ECU3 214) for the present hardware/software configuration data. The VCS 100 may then transmit the VIL data to the server via the cellular interface. The server 260 may compare the hardware/software configurations that are received from the electrified vehicle 231 with a set of preferred hardware/software configurations. If an updated software version is available for the hardware, the server 260 may prepare instructions and files for updating the corresponding controller. The server 260 may send the instructions and software update files to the VCS 100 via the network 161 and through the cellular tower 157. The VCS 100 may receive the instructions and software update files and initiate reprogramming the corresponding controller. The VCS 100 may confirm that proper conditions are present for reprogramming. For example, the VCS 100 may check to ensure that the vehicle is in an off condition and has sufficient battery power to perform reprogramming.

While the OTA update scheme is beneficial, there may be ways to improve the process. The OTA update requires the VCS 100 to establish a cellular network connection with the server 260 to transfer the updated information. During this time, the VCS 100 is drawing battery power and, since the vehicle is generally in an off condition, reducing the battery state of charge. In addition, there may be limits to the amount of cellular data that may be used (e.g., per key cycle, per time period). Transferring large software update files may risk exceeding the cellular data limits. Alternatives to using the cellular link may be beneficial. These conditions may be improved if the process is performed during vehicle charging. When charging, there is less risk of draining the battery as power can be drawn from the charge station 240. In addition, an alternative communication channel may be utilized during vehicle charging to reduce cellular data usage.

The server 260 may also include a library of audio and video files. The video and audio files may be transferred to the VCS 100 upon request. The media files may be available for transfer at all times over the cellular interface. However, as described for the OTA update scheme, the transfers may be subject to limits and/or costs. An alternative communication channel may help reduce costs and prevent exceeding the limits.

As described, the charge controller 244 may be in communication with the network 161 and the electrified vehicle 231. The charge controller 244 may provide a communication link between the server 260 and the electrified vehicle 231. This communication channel may be utilized for transferring content including software updates to the electrified vehicle 231 during charging. Benefits of this arrangement are that a connection between the server 260 and charge station 240 may not rely on cellular data. In some cases, communication performance may be improved as a cellular signal is not required. For example, in some areas a cellular signal may be unreliable and establishing a cellular connection may be ineffective.

In some configurations, the VCS 100 may transfer data to the charge port controller 244 when the charge plug 248 is coupled to the charge port 202. For example, the VIL data may be transferred. The charge controller 244 may transfer the VIL data to the server 260 via the network 161. The server 260 may transfer software updates to the charge controller 244 which may then transfer the software updates to the VCS 100. This approach requires data to be transferred from the server 260 to the charge controller 244 and then to the electrified vehicle 231. The transfer of data may be time consuming. As charging technology improves (e.g., fast charging) the time spent coupled to the charge station may be reduced. As such, it may be beneficial to ensure that the transfer of content from the server 260 to the electrified vehicle 231 can be achieved in a shortest possible time.

A process may be in place for reserving the charge station 240. For example, vehicle operators may be able to reserve a particular time period for charging a vehicle at a charge station. The vehicle operator may utilize a nomadic device 153 to make a reservation for the charge station 240. The nomadic device 153 may be programmed to execute an application for reserving the charge station 240. The vehicle operator may select a reservation start/arrival time and a reservation end/departure time or a reservation duration. The server 260 (or a separate server) may be programmed to maintain a database of charge stations and reservations in order to manage the system. The nomadic device 153 may communicate with the server 260 through the network 161. In some configurations, the VCS 100 may be configured to provide an interface for making the reservation for the charge station 240 in the same manner as the nomadic device 153. In other configurations, the server 260 may be accessed from a webpage by any type of computing device using a web browser.

Upon executing the application on the nomadic device 153, the nomadic device 153 may request the VIL from the VCS 100. In some configurations, the VIL data may be maintained as part of a customer account. The VIL data stored in the account may be periodically updated, such as when a device is reprogrammed. The operator may select an available reservation time and the nomadic device 153 may transmit the VIL to the server 260. The server 260 may process the VIL to determine if the electrified vehicle 231 has any outstanding software updates. For example, assume that the vehicle operator has reserved the charge station 240 for a specified reservation time. If there are outstanding software updates, the server 260 may schedule the software updates to be transmitted to the charge station 240 prior to the reservation time. The charge station 240 may receive and store the software updates in memory. When the electrified vehicle 231 is coupled to the charge station 240, the software updates may be transferred to the VCS 100 over the data connection. The VCS 100 may transfer the software updates over the vehicle network 186 to the destination controller.

If software updates are available, the nomadic device 153 may be programmed to alert the operator that updates are available. The nomadic device 153 may be programmed to permit the operator to allow or prohibit the updates at the specific reservation time. The nomadic device 153 may be programmed to allow the operator to select which updates are to be installed.

The vehicle operator may also be able to select content for download to the electrified vehicle 231. For example, the nomadic device 153 may include an interface for selecting content to download to the electrified vehicle 231. Available content may be stored on the server 260 and the nomadic device 153 may be configured to access a list of the available content. The interface may also display a list of content that is currently downloaded to the electrified vehicle 231 to facilitate deletion of already played content. The nomadic device 153 may maintain a list of content to be downloaded. The digital content specified in the list may be transferred to the server 260 when the reservation is established. As the list may be updated at any time, the application may monitor for changes to the list and transmit the request to the server 260 in response to any changes while an upcoming reservation is present. The server 260 may schedule the content to be delivered to the charge station 240 prior to the reservation request. The charge station 240 may receive and store the digital content in memory. When the electrified vehicle 231 is coupled to the charge station 240, the digital content may be transferred to the VCS 100 over the data connection. For example, the VCS 100 may transfer the digital content over the vehicle network 186 to the VES 222. Content may include software updates and instructions, audio files, and video files.

Prior to sending the content, the server 260 may compute the amount of data to be transferred. For example, each of the files of the selected content may have an associated file size. The server 260 may compute of total content size by summing the size of each of the files to be transferred. The total content size may be transferred to the nomadic device 153. The nomadic device 153 and/or the server 260 may be configured to compute and/or store a data transfer rate between the electrified vehicle 231 and the charge station 240. The data transfer rate may be dependent on the type of connection between the electrified vehicle 231 and the charge station 240. The server 260 and/or the nomadic device 153 may be programmed to compute a download time for transferring the content from the charge station 240 to the electrified vehicle. For example, the download time may be a ratio of the total content size to the data transfer rate.

The server 260 and/or the charge controller 244 may be programmed to determine if sufficient time is available to complete the download of content during the reserved time interval. The server 260 and/or the charge controller 244 may compute an available download time as a difference between the reservation end time and the reservation start time. The available download time may be compared to the download time. If the download time exceeds the available download time, a notification or alert may be provided to the operator on the nomadic device 153 that insufficient time is available for the download. In such a case, the download may be cancelled. The operator may be permitted to eliminate content from the download so that sufficient time is available. If the download time does not exceed the available download time, notification may be provided to the operator on the nomadic device 153 that sufficient time is available for the download or that the download is likely to be successful.

The charge station controller 244 may be further programmed to request at least one vehicle-based controller (e.g., ECU1 210, ECU2 212, ECU3 214, VES 222) to stop communicating on a vehicle network 186 to allow increased bandwidth for transferring content to the destination controller. The charge station controller 244 may send an instruction to the VCS 100 to disable communication for controllers not receiving the content. For example, assume that content is to be transferred to ECU1 210. The VCS 100 may send a command to the other controllers (e.g., ECU2 212, ECU3 214, and VES 222) to disable communication on the vehicle network 186. This may increase the available bandwidth of the vehicle network 186 for transferring the content between the VCS 100 to ECU1 210. When the transfer is complete, the VCS 100 may send a command to the other controllers to re-enable communication on the vehicle network 186.

The charge station controller 244 may be further programmed to request a reduction in power to at least one vehicle-based system that is not receiving the content to offset power drawn by the vehicle controller that is receiving the content. The VCS 100 may send a command to the other controllers to enter a low-power mode of operation to reduce power consumption. This decreases the power draw of the vehicle and reduces traffic on the vehicle network 186. When the transfer is complete, the VCS 100 may send a command to the other controllers to exit the low-power mode of operation.

Note that features related to the charge station interface may be implemented in a controller separate from the VCS 100. For example, a charge station gateway controller may be implemented to manage the interface with the charge station 240. Such a configuration may allow the VCS 100 to be used in all types of vehicles without special programming and features for electrified vehicles. The charge station gateway controller may manage the physical interface with the charge station 240 and transfer data to the vehicle network 186.

Preloading the content to the charge station 240 enables faster transfers of the content to the electrified vehicle 231 as the transfer from the server 260 to the charge station 240 is already completed. This permits a higher volume of content to be transferred during a given time interval. Transferring the content in this manner also reduces the use of the cellular network which may be subject to limits. As the server may communicate with numerous charge stations, this scheme may also improve server communication by allowing the server more flexibility for scheduling data transfers to multiple charge stations.

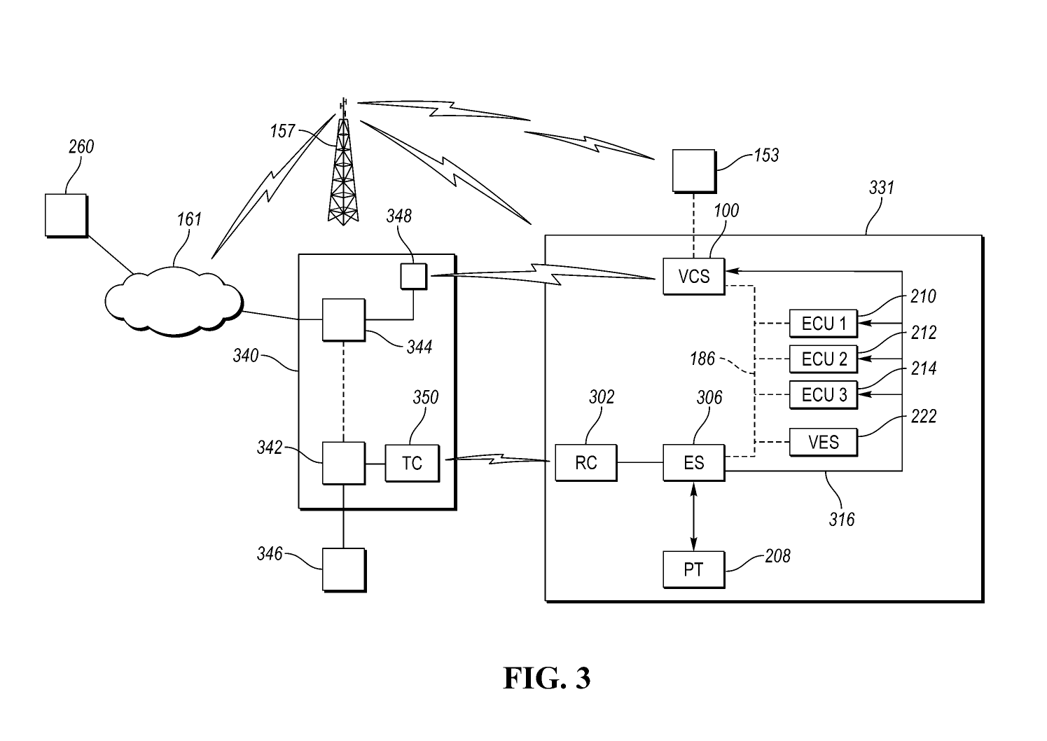

FIG. 3 depicts a vehicle charging system including an electrified vehicle 331 and a wireless charge station 340. The electrified vehicle 331 includes many of the features previously discussed in relation to FIG. 2 and those descriptions apply.

The electrified vehicle 331 may include a power receive coil 302 that is configured to receive power from the wireless charge station 340. The receive coil 302 may be electrically coupled to the energy storage module 206. The energy storage module 206 may include a power converter stage to convert power from the power receive coil 302 to a form usable by the batteries.

The wireless charge station 340 may include a power transfer module 342 that is electrically coupled to an external power source 346 (e.g., electrical grid). The power transfer module 342 may be electrically coupled to a power transmit coil 350. The power transmit coil 350 may be configured to induce current in the power receive coil 302 when the power receive coil 302 is proximate the power transmit coil 350. When the power receive coil 302 is proximate the power transmit coil 350, power may be inductively transferred to the vehicle to recharge the energy storage system 206. The wireless charging station 340 may operate by driving an alternating current (AC) through the power transmit coil 350 which induces an AC current in the power receive coil 302.

The charge station 340 may also include a charge station controller 344. The charge station controller 344 may be configured to control the operation of the power transfer module 342. The charge station controller 344 may also be configured to manage the operation and placement of the power transmit coil 350. The charge station controller 344 may include hardware and software components for detecting when the power receive coil 302 is proximate the power transmit coil 350. The charge station controller 344 may also be configured to operate the power transfer module 342 to select a current magnitude and frequency to drive through the power transmit coil 350. The charge station controller 344 may be configured to control a position of the power transmit coil 350.

The charge station controller 344 may include a wired and/or wireless Ethernet interface for establishing a connection with the network 161 and/or cloud. The charge station controller 344 may include hardware circuitry and software drivers to operate the network interface.

The wireless charge station 340 may include a wireless network interface 348 that is operated by the charge station controller 344. The wireless network interface 348 may be any wireless interface such as a wireless Ethernet, Bluetooth, NFC, and/or DSRC. Communication between the wireless charge station 340 and the electrified vehicle 331 may be performed without a physical connection. The charge station controller 344 may include hardware and software drivers to implement the wireless communication protocol. The data transfer rate may depend on the type of wireless interface that is selected.

Operation of the wireless charge station 340 is similar to that described for the configuration of FIG. 2. The main difference is that there is no physical connection between the wireless charge station 340 and the electrified vehicle 331. All features described in relation to the system of FIG. 2 apply to the wireless configuration and are not repeated here.

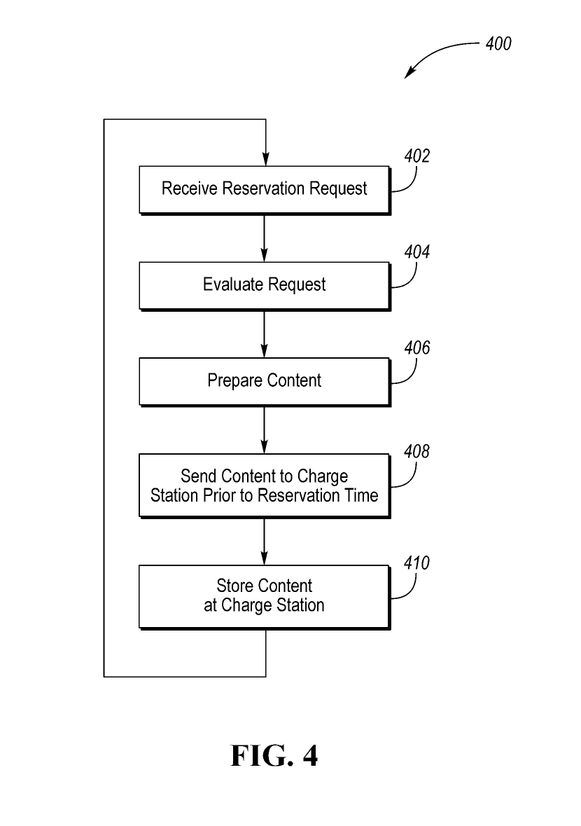

FIG. 4 depicts a flow chart 400 of a possible sequence of operations for implementing the vehicle charging system. The operations may be implemented in one or more controllers (e.g., charge station controller 244, server 260, and/or VCS 100). At operation 402, a reservation request may be received (e.g., by server 260). The reservation request may be received through the network 161 and may be initiated by the nomadic device 153 or the VCS 100. The reservation request may include content request data. The content request data may include VIL and/or vehicle identification information. The content request data may include identifiers for specific audio or video content that may be available. The reservation request may include data indicative of a reservation start time and a reservation end time.

At operation 404, the reservation request may be evaluated by the receiving controller (e.g., server 260). For example, the receiving controller may evaluate the VIL information to determine if any software updates are preferred. The controller may compare hardware and software identifiers from the VIL with a database of most recent versions to determine if a software update is available. The controller may evaluate the request for any media files that are requested. The controller may also determine if there is sufficient time available during the reservation to transfer the content to the electrified vehicle. The controller may send a notification to the requesting device indicative of sufficient or insufficient time available.

At operation 406, the controller may prepare the content for delivery to the charge station. The controller may retrieve files that are to be sent and schedule a delivery time that is prior to the reservation time. The controller may determine a time duration required for transmitting the content to the charge station. The controller may initiate a test of the data connection to determine a transfer rate.

At operation 408, the controller may send the content to the charge station prior to the reservation time. The server 260 may transmit the content to the charge station such that the content is received before the reservation start time. The server 260 may begin the transmission to the charge station approximately the time duration before the reservation start time.

At operation 410, the content is stored at the charge station. The charge station may store the content in memory of the charge station controller for later retrieval at the reservation start time. The content may be stored with vehicle identification information to ensure that the content is downloaded to the correct vehicle.

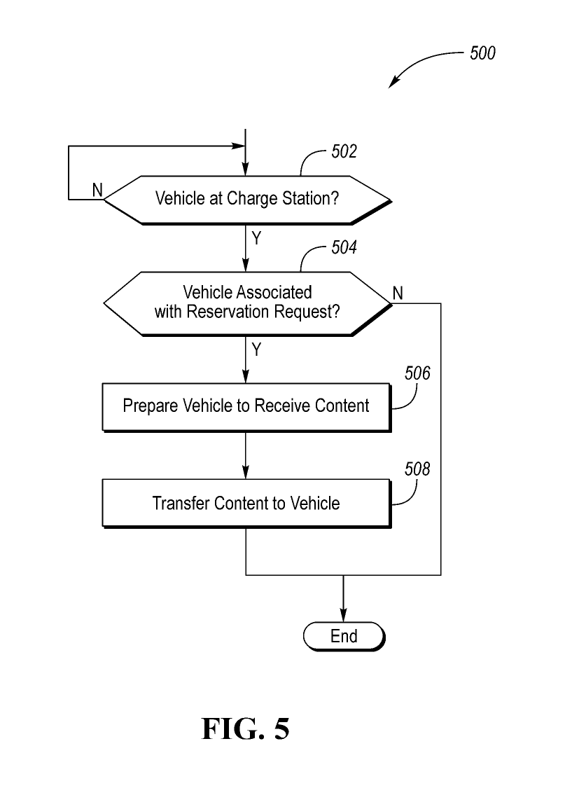

FIG. 5 depicts a possible flow chart 500 for implementing the vehicle charging system. At operation 502, the charge station may monitor if a vehicle is at the charge station. The charge station controller may detect the presence of the vehicle by various sensors (e.g., tire pad, camera, proximity sensors). In addition, the presence of a vehicle is detected when a vehicle is plugged in and/or establishes communication with the charge station. If no vehicle is detected, operation 502 may be repeated. Upon establishing communication, the vehicle may transfer vehicle identification information to the charge station.

If a vehicle is detected, operation 504 may be performed. At operation 504, the charge station controller may determine if the electrified vehicle is associated with a reservation request. The charge station may be storing content for multiple vehicles. If a vehicle is detected at the charge station, the controller may check the stored content and associated VIL information to determine if there is any content corresponding to the vehicle that is present. If there is no matching information for the vehicle, then the sequence may end.

If there is content corresponding the vehicle, then operation 506 may be performed. At operation 506, the controller may prepare the vehicle to receive the content. For example, diagnostic commands may be sent to the vehicle controllers to enter the correct mode for receiving software updates. The controller may request that controllers not receiving content stop communicating on the vehicle network or enter a low-power mode. In addition, the controller may ensure that the power connection is transferring power or at least capable of transferring power the to the vehicle.

At operation 508, the content is transferred to vehicle. over the data connection between the charge station and the vehicle. After the content is transferred, the sequence ends until a different vehicle enters the charge station, at which time the sequence may be repeated.

The vehicle charging system described provides a cost-effective way of transferring large amount of data to the vehicle. By preloading the content to the charge station, download times can be reduced. Further, the vehicle does not have to rely on a cellular connection while at the charge station. The system and methods reduce the amount of cellular data usage which may reduce cost.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes may include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A charge station comprising:
a controller in communication with a server and programmed to, responsive to receiving a reservation request including content request data, request the server to send content to the controller prior to a reservation start time, receive and store the content, and, responsive to a vehicle associated with the reservation request receiving power from the charge station, transfer the content to the vehicle.

2. The charge station of claim 1 wherein the content request data includes a vehicle interrogator log with a vehicle identification number and hardware and software identifiers for programmable controllers within the vehicle.

3. The charge station of claim 1 wherein the content request data includes a request for one or more media files.

4. The charge station of claim 1 wherein the reservation request includes the reservation start time and a reservation end time and the controller is further programmed to generate an estimated vehicle download time and, responsive to the estimated vehicle download time exceeding an amount of time corresponding to a difference between the reservation end time and the reservation start time, generate output to notify a requestor of insufficient time for downloading.

5. The charge station of claim 1 wherein the controller is further programmed to request at least one vehicle-based controller to stop communicating on a vehicle internal communication network to allow increased bandwidth for transferring content.

6. The charge station of claim 1 wherein the controller is further programmed to request a reduction in power to at least one vehicle-based system that is not receiving the content to offset power drawn by a vehicle controller that is receiving the content.

7. The charge station of claim 1 wherein the controller is further programmed to generate an estimated vehicle download time and communicate the estimated vehicle download time associated with the content to a requestor.

8. A vehicle charging system comprising:
a server programmed to, responsive to receiving a reservation request for a charge station including a content request associated with a vehicle, send content corresponding to the content request prior to a reservation start time to a controller associated with the charge station and programmed to store the content and, responsive to the vehicle receiving power from the charge station, transfer the content to the vehicle.

9. The vehicle charging system of claim 8 wherein the content request includes a vehicle interrogator log with a vehicle identification number and hardware and software identifiers for programmable controllers within the vehicle.

10. The vehicle charging system of claim 8 wherein the content request includes a request for one or more media files.

11. The vehicle charging system of claim 8 wherein the reservation request includes the reservation start time and a reservation end time and the server is further programmed to, responsive to an estimated vehicle download time exceeding an amount of time corresponding to a difference between the reservation end time and the reservation start time, generate output to notify a requestor of insufficient time for downloading.

12. The vehicle charging system of claim 8 wherein the controller is further programmed to request at least one vehicle-based controller to stop communicating on a vehicle internal communication network to allow increased bandwidth for transferring content.

13. The vehicle charging system of claim 8 wherein the controller is further programmed to request a reduction in power to at least one vehicle-based system that is not receiving the content to offset power drawn by a vehicle controller that is receiving the content.

14. A method comprising:
receiving, by a server, a reservation request for a charge station including a reservation time and vehicle identification data for a vehicle, selecting a software update corresponding to the vehicle identification data, and sending the software update to a charge station for storage prior to the reservation time; and
downloading, by the charge station, the software update to the vehicle responsive to the vehicle receiving power from the charge station.

15. The method of claim 14 wherein the vehicle identification data includes a vehicle identification number and hardware and software identifiers for programmable controllers within the vehicle.

16. The method of claim 14 wherein the reservation request includes a content request for one or more media files.

17. The method of claim 16 further comprising
sending, by the server, the media files to the charge station for storage prior to the reservation time; and
downloading, by the charge station, the media files to the vehicle responsive to the vehicle receiving power from the charge station.

18. The method of claim 14 further comprising estimating, by the server, a download time to the vehicle for the software updates.

19. The method of claim 18 wherein the reservation request includes an arrival time and a departure time and the method further comprising, responsive to the download time exceeding an amount of time corresponding to a difference between the departure time and the arrival time, notifying a requestor of insufficient time for downloading.

20. The method of claim 18 wherein the reservation request includes an arrival time and a departure time and the method further comprising, responsive to the download time being less than an amount of time corresponding to a difference between the departure time and the arrival time, notifying a requestor of sufficient time for downloading.
